(19) United States
(12) Patent Application Publication
(10) Pub. No.: US 2012/0130817 A1
(43) Pub. Date: May 24, 2012

(54) Method for Delivery of Relevant Consumer Content Based on Consumer Journey Patterns

(76) Inventors: Robert Bousaleh, Weymouth, MA (US); Jason Paul Mathew, Johnston, RI (US)

(21) Appl. No.: 13/290,072

(22) Filed: Nov. 5, 2011

Related U.S. Application Data
(60) Provisional application No. 61/415,833, filed on Nov. 20, 2010.

(51) Int. Cl. G06Q 30/02

(52) U.S. Cl. 705/14.58

(57) ABSTRACT

A method providing highly relevant offers based on an individual's historic journey patterns prior to a future journey in order to influence the individual's behavior during a journey or when the individual departs from or arrives at predetermined headquarters or locations that are discerned using location-based and/or timing-based technologies. Other information can be used to discern and/or enhance the individual's journey patterns. An individual's journey pattern information includes location, route, timing, and/or duration information about one or more journey cycles by an individual, for example, two or more, three or more, four or more, or five or more journey cycles of the individual. A single journey cycle can include a time window at the same or similar time periods, for example, at the same or similar time in a day, at the same or similar time in a week, month, and/or year.

### CROSS REFERENCE TO RELATED APPLICATIONS

This application claims priority from U.S. Provisional Patent Application Ser. No. 61/415,833, entitled “Method for Delivery of Relevant Consumer Content Based on Consumer Journey Patterns”, filed on 20 Nov., 2010.

### FEDERALLY SPONSORED RESEARCH

Not Applicable

### SEQUENCE LISTING OR PROGRAM

Not Applicable

### TECHNICAL FIELD OF THE INVENTION

The present invention relates generally to the field of information delivery. More specifically the present invention relates to the field of journey pattern information recognition and delivery.

### BACKGROUND OF THE INVENTION

It is often desirable to deliver relevant and timely information to selected individuals such as consumers. Several approaches have been used to aid in the delivery of targeted information to selected individuals. For example, information has been delivered via electronic means to individuals who are present with their smart phones or other devices in a particular location. Consumers with a smart phone or other device who are present within a certain distance from a vendor may receive targeted information. Alternatively, information has been delivered via electronic means to selected individuals having certain purchasing histories. However, these approaches have drawbacks. When delivering information to individuals who are present with their cell phones in a particular location, many of those individuals may have no interest in the information at that time. For example, an individual may be passing through the particular location with no interest in stopping and/or shopping in that location. When delivering information based on purchasing history, the purchasing history must be collected from a vendor or bank or debit card company. Such information may be difficult to obtain and has various personal data security implications. Accordingly, new approaches are needed for delivering relevant and timely information to select individuals.

### SUMMARY OF THE INVENTION

The present invention teaches a method for delivery of relevant consumer content based on consumer journey patterns. The present invention teaches a method related to the field of discerning journey pattern information for selected individuals and supplying to those individuals timely and relevant information based on their particular journey patterns.

The features and attendant advantages of the present invention will become better understood by reference to the following detailed description of the invention when taken in conjunction with the accompanying examples. The various embodiments described herein are complimentary and can be combined or used together in a manner understood by the skilled person in view of the teachings contained herein.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 provides a graphical view of one embodiment of the systems and methods described herein;

FIG. 2 provides a customer view of their interaction cycle between the different establishments and the application;

FIG. 3 depicts a system diagram showing aspects of an embodiment of the systems and methods described herein;

FIG. 4 is a flow chart illustrating the alert flow process method of the present invention;

FIGS. 5a and 5b are a flow charts illustrating the redemption flow process method of the present invention;

FIGS. 6a and 6b are flow charts illustrating the Beamed Offer embodiment of the present invention;

FIG. 7 is a flow chart illustrating the Proximity Offer embodiment of the present invention;

FIG. 8 is a flow chart illustrating the Browsed Offer embodiment of the present invention;

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or the entire group members are present in, employed in, or otherwise relevant to a given product or process. Furthermore, it is to be understood that the invention encompasses all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. Where elements are presented as lists, e.g., in Markush group or similar format, it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification.

The present invention provides highly relevant offers based on an individual's journey patterns that are discerned using location-based and/or timing-based technologies. The present invention is a method providing highly relevant offers based on an individual's historic journey patterns prior to a future journey in order to influence the individual's behavior during a journey or when the individual departs from or arrives at predetermined headquarters or locations that are discerned using location-based and/or timing-based technologies.

“Journey” for the purposes of the present invention and this application is defined as “an act of traveling from one place to another”. In most instances, in this document, when referring to a “journey” the document or example is referring to a shopping trip or the process of a customer, individual, or group traveling from one store or place of business to another, but a journey can also refer to a customer, individual, or group traveling to from any one place to another, such as their home or work location(s).

Optionally other information, including but not limited to customer offer feedback and/or customer preferences, can be used to discern and/or enhance the individual's journey patterns. An individual's journey pattern information can include, but is not limited to, location, route, timing, and/or duration information about one or more journey cycles by an individual, for example, two or more, three or more, four or more, or five or more journal cycles of the individual. A single journey cycle can include, but is not limited to, a time window (e.g., minutes, hours, days, months, and/or years) at the same or similar time periods, for example, at the same or similar time in a day, at the same or similar time in a week, at the same or similar time in month, and/or at the same or similar time in a year. For example, similar time periods can include each weekday between 7 am and 9 am, each weekend day before noon, within the first five days of every month, and/or the same month or season of every year.

Alternatively or in addition, an individual's journey pattern information can include but is not limited to sequence information. For example, an individual's journey behavior may include frequently visiting Location B within a certain time period after visiting Location A. This sequencing pattern may or may not occur within a particular time window (e.g., at a same or similar time in and/or during a day, week, month or year).

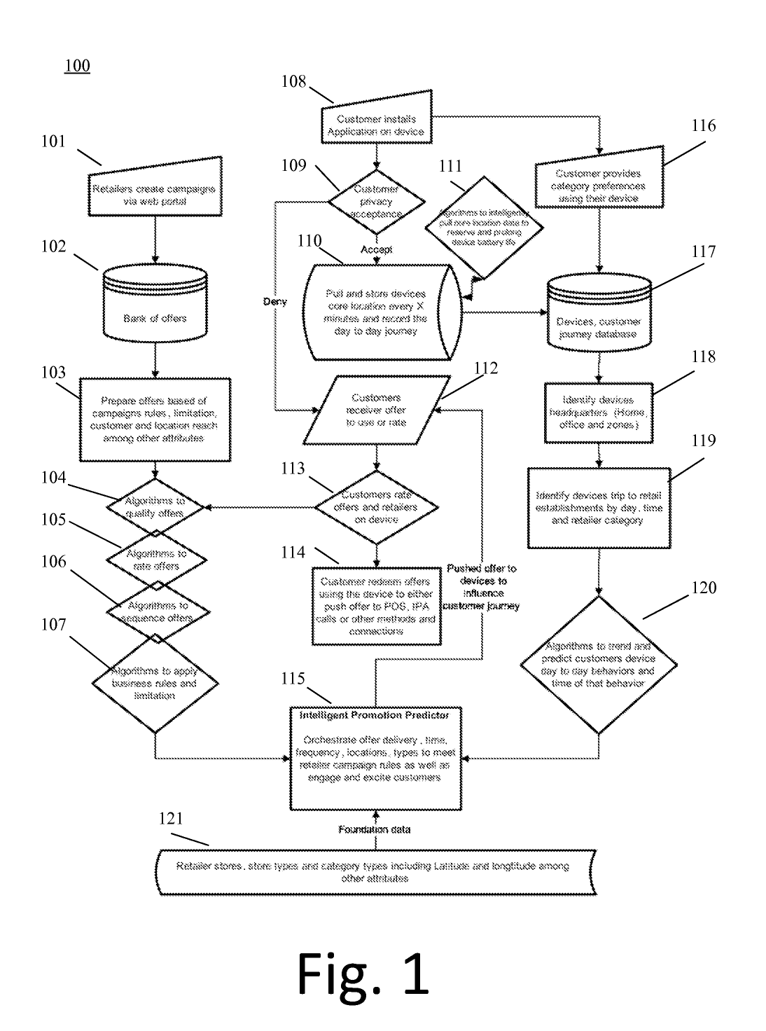

Now referring to FIG. 1, FIG. 1 provides a graphical view of one embodiment of the systems and methods 100 described herein. In particular, FIG. 1 starts with the customer installing and subscribing to the application from a device 108, and then depicts exemplary methods for analysis of the customer shopping patterns and for generating qualified offers to communicate back to the customers 112. FIG. 1 also exemplifies the customer's ability to rate the offers to add influence to the type of offers received 113.

To engage the system and method of the present invention a user first installs a computer application on a device 108 that runs software providing execution of the method instructions taught by the present invention and accepts a privacy notice 109. Upon acceptance, the devices core location is pulled and stored periodically and repeatedly for a given period of time to record the customer's day to day journey 110. Algorithms are used to intelligently pull core location date information to reserve and prolong battery life of the device 111. The customer provides category preferences 116 which is stored with the journey information in a database 117. The device records and identifies headquarters such as the home, office, and other zone locations 118 as well as trips to retail establishments by day, time, and retailer category 119. Algorithms are used to trend and predict a customer's device day to day behaviors and time of that behavior 120. An Intelligent Promotion Predictor 115, orchestrates offer delivery, time, frequency, locations, types to meet, retailer campaign rules as well as engaging customers by using the algorithms used to trend and predict a customer's device day to day behaviors and time of that behavior 120, foundation data 121 gathered from retailer stores, store types, category types including latitude and longitude among other attributes. The Intelligent Promotion Predictor 115 can push offers to devices to influence the customer journey and provide customers with offers to use or rate 112.

Retailers create campaigns via a web or other electronic portal that allows them to access the computer system executing the method of the present invention 101. A database provides a bank of offers 102 created by retailers for presentation to customers. Offers are prepared based on campaign rules, limitations, customers, and location reach among other attributes 103. When offers are prepared 103 or when a customer rates an offer 113 a series of algorithms qualifies the offer 104, rates the offer 105, sequences the offers 106, and applies any desired business rules and limitations to the offers 107 before delivering them to the Intelligent Promotion Predictor 115 for future presentment to a customer 112.

In the event a customer denies the privacy terms they will only receive offers to use or rate 112 that are not based or determined by their location, as provided to the system by the device. Customers can then rate offers and retailers on their device 113 and/or redeem offers using the device to either push the offer to a POS, or push and redeem via API (Application protocol interface) calls, or other methods and connections 114.

Based on the individual's past journey pattern information, and optionally other information about the individual's journey behavior, the system predicts future journey patterns and journey behavior of that individual. Based on those predictions, certain relevant, targeted information can be delivered to the individual, for example, at an optimum time in advance of their predicted journey to that location. For example, a consumer having a journey pattern that includes stopping for coffee between the time she parks her car and walks to work can be sent an offering for coffee just before she leaves her house in the morning. The information can be communicated via various means and to various devices. For example, the information can be transmitted to the individual's smart phone, computer, or device as an e-mail, text message, or phone call. push notifications or internal device alerts.

The information can be transmitted to any one or more communication devices, for example but limited to, an individual's smart phone or other hand-held device, a mobile personal computer or device (e.g., a laptop computer or a computer integrated into a vehicle), and/or a stationary personal computer or device (e.g., a home or work computer). The present application provides one or more of location, route, timing, duration, and/or sequence-based relevant targeting using smart phones and/or other device technologies to serve as the Graphic User Interface (GUI) to interact with customers. This approach tracks the customer's daily, day-to-day, weekly, monthly, or annual journey by receiving signals from his or her smart phone and/or device. Location-based core technologies include but are not limited to, for example, cell tower triangulation, WiFi and/or GPS. In certain embodiments, incentives, for example, coupons or other discounts can be provided to customers based on one or more of location, route, timing, duration, and/or sequence feedback via their GUI to enhance relevancy. The offers delivered to customers are highly relevant because of the system's understanding of the customer's journey behavior. By tracking the customer journey behavior, the system can predict a customer's behavior(s), such as the location, route, timing, duration, and/or sequence of the customer's travels, as well as the different retailers and retailer categories that the customer enjoys shopping at. Hence, the system understands where and when a customer is likely to shop.

In addition, the system can build a location affinity and correlation between the different establishments. For example, a customer normally visit establishment B after visiting establishment A. In certain embodiments, a rule can correlate that sequence by creating a relationship between A & B and B & A and/or optionally C & D, D & C, and/or any combination, and/or relationships between establishments that have similar product lines, for example, A & X̂ 1 & X̂2 etc. . . . These data elements can be used to generate analysis to select relevant promotions and offers to communicate back to the customers to non-intrusively influence their journey to visit establishment B or a like establishment, such as X.

Using these metrics, as well as other optional metrics such as customer feedback, customer profiling, customer purchasing history, and/or other customer preferences, the system can qualify offers from an offer bank and rank them for each customer, thereby increasing the redemption rate and relevancy of these offers. Moreover, in certain embodiments, the system can deliver these offers at relevant times for that customer, such as just before a customer is predicted to engage in a predicted step in their particular journey pattern. For example, the system can deliver a lunch offer 10 or 15 minutes prior to a particular customer's patterned weekday lunch behavior, optionally from a vendor that the customer may typically visit or, alternatively, from a vendor that the customer may typically not visit. As another example, based on a customer's journey pattern(s) (e.g., based on his historical travel location(s) such as origination, destination, and/or stopping locations; travel route; travel timing; travel duration; and/or travel sequence information) an offer from a retailer can be delivered to the customer once the customer has parked in front of the retailer, and/or at one stop prior that that customer's patterned journey to the retailer, and/or just before the customer leaves his house in the morning of his patterned journey to that retailer. Additional examples include a system that can deliver offers to a customer that visits establishment A, who has an existing pattern to visit a different type of an establishment. Another example is customer profiling a group of customers to be in a similar grouping based on, for example, but not limited to, their shopping journey, offer feedback and preferences, and/or other common features. Because they are in a similar grouping, conclusions of shopping patterns, retailer interest and offer relevancy can made and matched with the offers and promotions to deliver to the customers.

The system described herein is a win-win approach for customers and retailers. Customers receive highly relevant and rich offers at the best time and/or in the best location for their journey, instead of being overwhelmed with low value offers. Optionally, the customers can control the sharing of these offers with their friends and family, for example, via one or more social media deliveries including but not limited to e-mail, Facebook, Twitter and others.

Moreover, in certain embodiments, customers can provide feedback for the offerings. For example, customers can instruct the system to stop sending particular offers or types of offers. Alternatively or in addition, customers can instruct the system to send more particular offers or types of offers. In certain embodiments, customers can rank the offers based on various criteria including, for example, personal taste or appeal. While the personal optimization of offerings provides incentives for the customers to provide feedback, additional incentives for customers to provide feedback can be provided, such as reward discounts. The customers can provide feedback, such as rating an offer, using the GUI. The feedback can then be used by the system and retailers to provide highly valuable offers or improve their offerings or services (or suffer continuing bad ratings) while customers enjoy the additional savings. For example, customers may favor a particular retailer using the GUI. In return, the customer may receive more relevant offers from that retailer.

The advantages of this system are attractive to retailers because it provides retailers a predictive understanding of a customer's journey and, optionally, with feedback about the retailer's offerings and/or services. This understanding can be used to comprehend, and close the competitive gap with respect to, a customer's tendency to journey to or toward the retailer's location or, alternatively, to or toward a competing retailer's location. This data allows retailers to communicate more directly and meaningfully with existing and/or potential new customers. For example, in certain embodiments, a retailer can send offers to potential new customers and deliver highly rich offers at an optimum time or place with respect to when those potential new customers journey to a competitor's establishment. In certain embodiments, a retailer simply can reward and further engage existing customers. For example, a “thank you” notification can be delivered to a customer once the customer has completed their journey to the retailer's establishment and/or a greeting can be delivered to a customer when the customer is arriving at or leaving the retailer zone/store.

As described above, this system generates systematic and deep understanding of a customer's journey patterns, for example, daily, day-to-day, weekly, monthly, or annual journey patterns, by capturing core location, route, timing, duration, and/or sequence information from a customer's smart phone and/or other devices. The data capture of a customer's location, route, timing, duration, and/or sequence information can be for any duration, for example, the data capture can be continuous or periodic. For example, to help preserve and prolong the battery life of the smart phones and/or devices, the data capture of a customer's location, route, timing, duration, and/or sequence information can be periodic. Rules can be included in the system to control how often the smart phones and/or other devices return core location signals back to a main server database. These rules can be based on a change frequency of signals if the devices are moving at a high rate of speed or simply not moving at all. These rules also can assess if the devices are in sleep mode, have a low battery, and/or if the devices are on the move, for example as the customer is shopping from retailer to retailer. In certain embodiments, a rule can be used to alter data capture frequency from a customer's smart phone and/or other devices based on the customer's location. In certain embodiments, a rule can be used to alter data capture frequency from a customer's smart phone and/or other devices based on the customer's feedback. For example, a customer can choose to shut off data capture, such as during certain times of the day, during low battery periods, for privacy reasons, and/or for any reason the customer may choose not to engage with the tracking feature of the system. The process can still target the customer relevantly by using previous journey information, customer profiling, customer preferences, and/or customer feedback on offers and retailers.

In certain embodiments, signals from the customer's smart phone and other devices, including information about the devices' core locations, cell tower triangulated location, WiFi, GPS, geo-fencing and other location, route-, timing-, duration-, and/or sequence-based information can be collected in order to capture a customer's daily shopping journey. In certain embodiments, the customer's home location and other key locations (work, school, friend's house, and/or other regular locations) at which a customer spends a majority of time also can be collected, optionally in addition to the duration, time, and/or sequence of the customer's journeys. For example, the time of day when a customer's departures and arrivals are made from and to the home location(s) can be included in the data capture and journey pattern recognition. The location(s) and type of establishment(s) visited as well as the times of day, week, month or year, frequency, and/or duration of the visits also can be collected. All of these data can be processed by one or more rules that determine a customer's shopping journey pattern, for example, the customer's daily, day-to-day, weekly, monthly, or annual shopping journey pattern, which can be used to deliver specific and highly relevant offers and product discounts that can be pushed or pulled in a timely manner to or from the customer's smart phone and/or other devices and presented to the customer by a graphical user interface application. For example a customer's journey pattern on Friday night may be to stop at a take-out establishment (pizza, subs, etc) for dinner and bring it home. This pattern can be recognized and used to provide relevant offers, such as a coupon for take-out food, at a relevant time, such as at the end of the person's work-day, just before he departs for home.

The offer data pushed to or pulled from the customer's smart phone and/or other device can be provided directly by retailers and other establishments. Alternatively, or in addition, the offers can be provided based on rules that match offers from an offer bank. The offer bank can include offers provided in advance by the retailers. In certain embodiments, a retailer can participate in setting the parameters for the rules that push or pull its offer(s) from the offer bank to or from the customer's smart phone and/or other device. For example, in certain embodiments the system can allow the retailers to select individuals who meet certain journey pattern criteria (e.g., who have journey patterns with some relationship to their establishments) to send them customized offers based of the retailers' program strategy. Optionally, the system can allow the retailers to select or further select customers who either have attended their establishments or their competitors' establishments.

In certain embodiments, the rule criteria for optimizing offers can include various additional types of information. For example, a customer's journey pattern information can be used in addition to the customer's prior offer preference data, offer feedback data, and offer ratings data (whether positive or negative). In this way, the most relevant and timely offers can be delivered to the customer via the GUI on the smart phone and/or other devices.

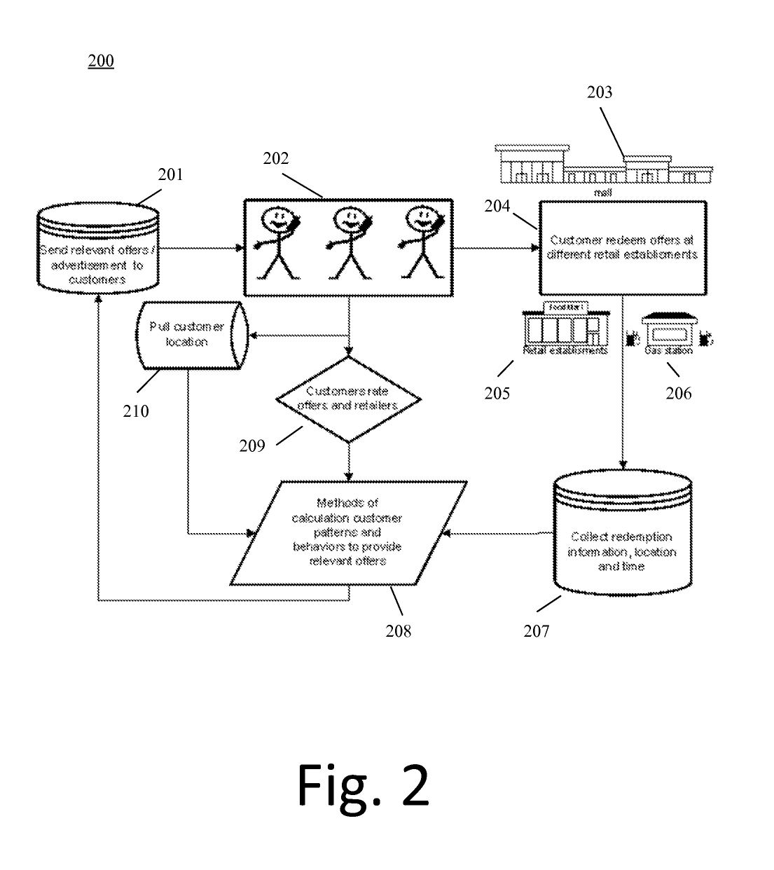

Now referring to FIG. 2, FIG. 2 provides a customer view of their interaction cycle between the different establishments and the application system and method of the present invention 200. Relevant offers/advertisements are sent to customers 201. Customers receive and review the offers 202 and may rate them 209. Customers then redeem offer at different retail establishments 204 such as, but not limited to, the mall 203, a grocery store or other retail establishment 205, and/or a gas station 206, as part of their daily journey. The system collects redemption information, location, and time 207. Methods of calculation determine customer patterns and behaviors to provide relevant offers 208 which may include a customer's rating of an office 209 and/or their location 210. The calculation and determination 208 is then used to further generate and send relevant offers and advertisements to customers 201 in a repeating process.

Understanding a customer's journey patterns, for example, historical daily journey beginning at their home location and following the duration and order in which the customer visits each location throughout the day, produces historic data that can be used by the system to determine what offers to push to or be pulled from the customer's mobile device before the customer actually arrives to any particular location. For example, relevant offers can be delivered before a customer departs from their home in the morning or before she departs or arrives at some other key location—in advance of actually arriving at a location that matches an offering, for example, in advance of arriving in the vicinity of a retailer during a shopping trip. In this way, offers can be pushed or pulled using the customer's historical journey pattern(s) in order to influence or even create the customer's purchasing habits and, by extension, their future journey patterns, e.g., their future shopping journey patterns. This is a substantially different concept than simply detecting the customer's current location and sending them offers from a retailer within close proximity.

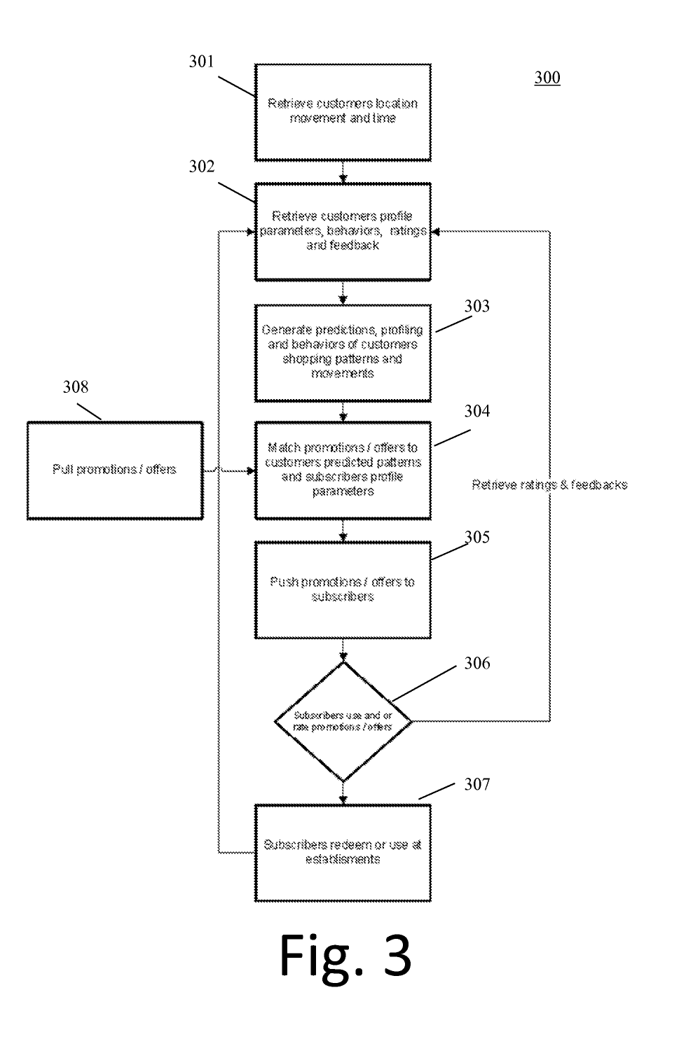

FIG. 3 provides a graphical view, but not limited to the systems interaction points between the different processes 300. Now referring to FIG. 3, a customer's location movement and time is first retrieved 301. The customer's profile parameters, behaviors, ratings, and feedback are retrieved 302. Predictions, profiling, and behaviors of customers shopping patterns and movements are generated 303. Promotions/offers are then pulled 308 and matched to customer's predicted patterns and subscriber profile parameters 304. Promotions/offers are then pushed to the subscriber 305 who then either use or rate the promotions/offers 306. If the subscriber provides a rating or feedback, that information is added to their profile and retrieved in the future when step 302 is repeated. If the redeems or uses the offer at an establishment 307, that information is added to their profile and retrieved in the future when step 302 is repeated.

In certain embodiments, the offers or other notifications, such as offer reminders and “thank you” messages, can be pushed to the customer's devices during the shopping journey to enhance customer engagement. For example, an offer reminder message can be pushed to a mobile device once the customer has parked in front of a retailer or a “thank you” message can be sent after the customer has redeemed an offer and is leaving the parking lot of a retailer.

As long as the application of the present invention is used with the default privacy settings, the application will utilize the smart phone's GPS to save data points once per minute as long as the smart phone does not remain in the same geographic area for a period of more than 60 minutes (parameter driven). After 60 minutes within the same geographical area, the GPS will be disabled and will not resume unless the smart phone switches to a new cellular connection. This step is taken to preserve smart phone battery life.

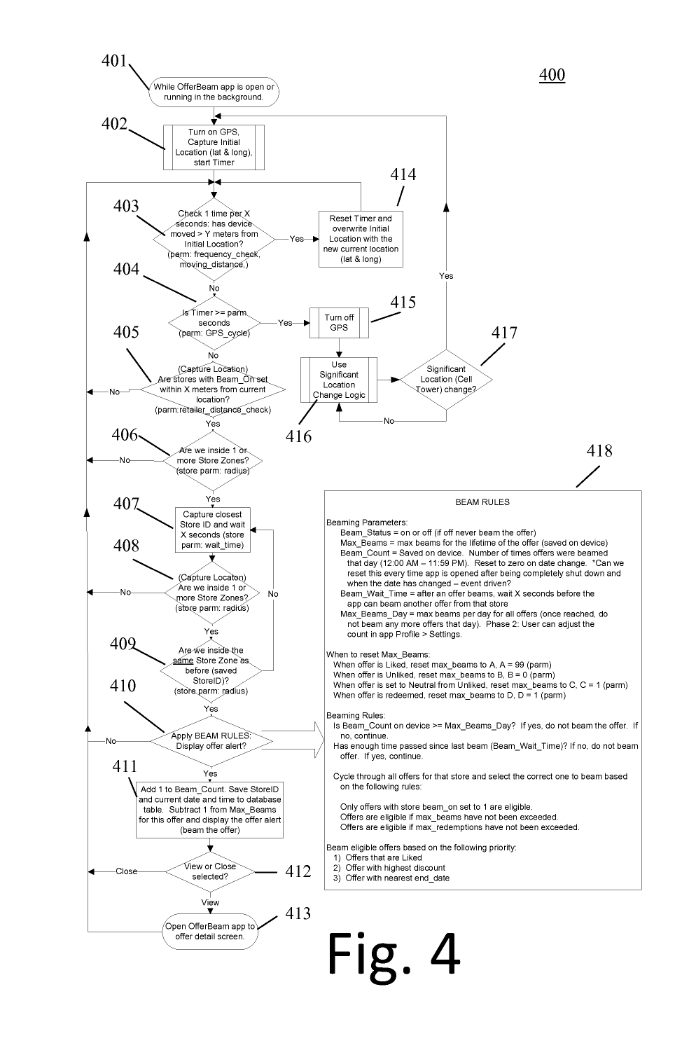

FIG. 4 illustrates how the mobile application of the present invention will track the smart phone's geo-location and “beam” (transmit) offer alerts via push notification and/or internal device alerts to the smart phone whenever the user is in close proximity to a shopping location downloaded to the phone.

Still referring to FIG. 4, the alert flow process method 400 of the present invention is disclosed. While the application is open and running 401, the initial GPS location (latitude and longitude) data is captured and the timer started 402. The system will then check periodically to determine if the device has moved 403. If the device has moved the timer will reset and overwrite the initial location with the new current location (latitude and longitude) 414. If, no new location is detected the time will continue 404 and then turn off the GPS 415 and use the significant location change logic 416 to detect a significant location change event such as a cell tower change 417. When such an event occurs the GPS will turn on 402 and the process repeat.

If a location is captured, the system will determine location distance from stores and determine if a threshold distance is met 405 and if the location is within a store zone 406. The process will then capture the location and check again after a wait time 407 to determine if the location has changed and if the location is still within a store zone 408 or if the location is still in the same store 409. If the location is within the same store 409, beam rules 418 will be applied 410 and a beam count will be added as well as the store ID and current date and time are stored in a database and the offer is displayed 411. The offer is then selected to be viewed or closed 412 and details provided if view is selected 413. If any of the decision steps 405-412 are not positive, the returns to step 403 and waits for the wait time to expire to run a location check 403.

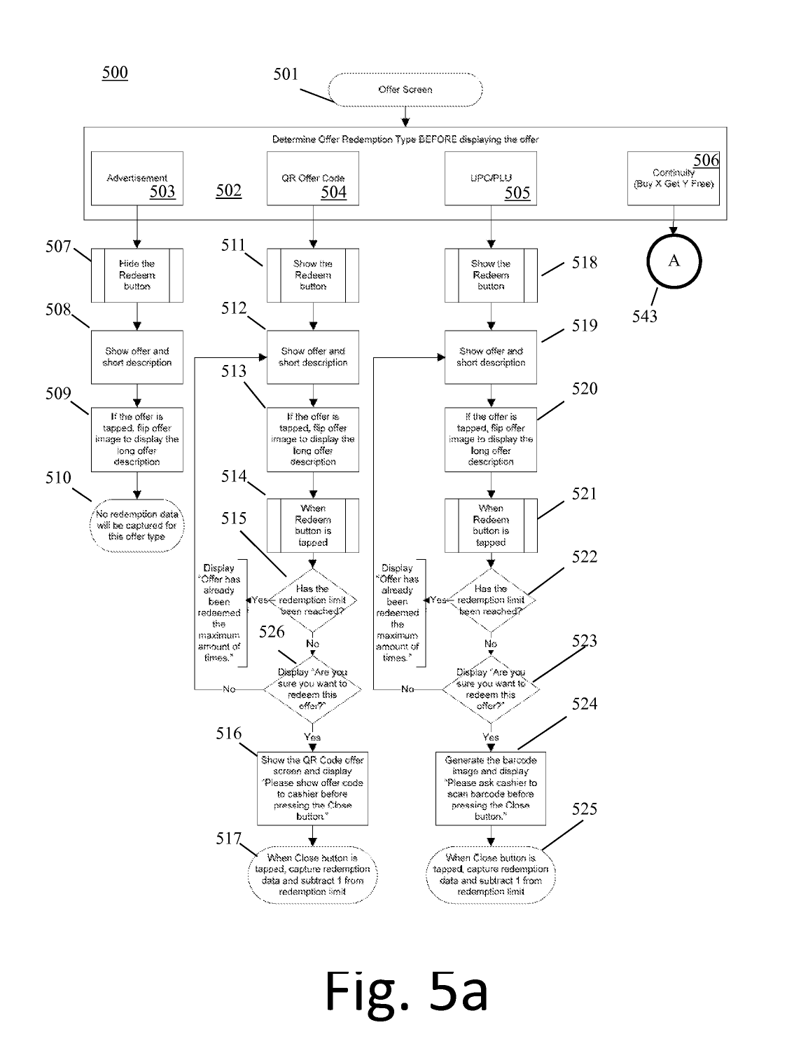

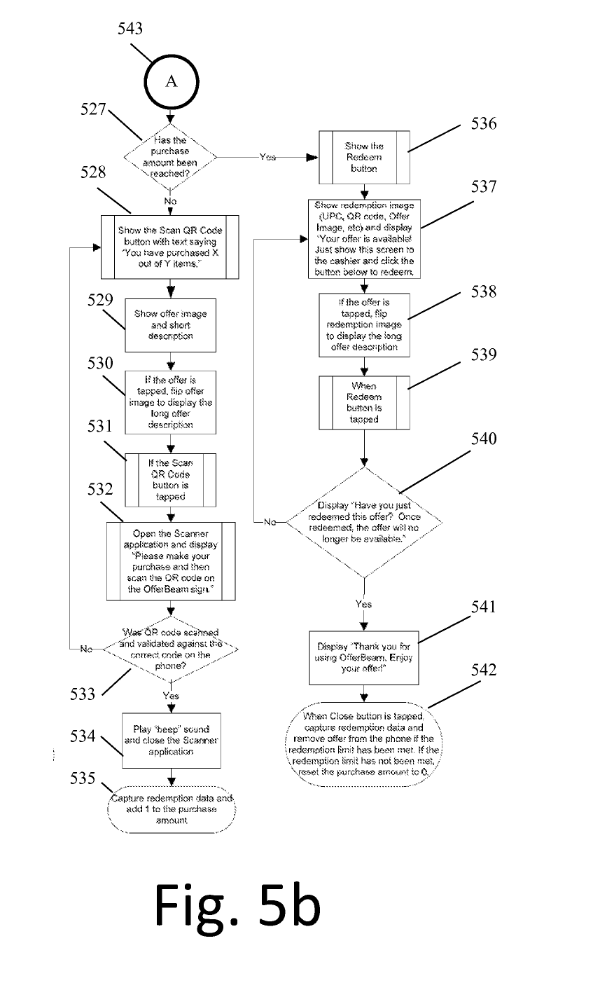

FIGS. 5a and 5b are flow charts illustrating the redemption flow process method 500 of the present invention. Before displaying the offer on the offer screen 501, the redemption type must be first determined 502. The four sub-processes for making and displaying the offer are the advertisement 503, OR offer code 504, UPC/PLU 505, and Continuity (Buy X Get Y Free) 506.

With respect to the advertisement 503, the redemption button is hidden 507, and the offer and short description is shown 508. If the offer is tapped via a touchscreen device or otherwise selected, the long description is then displayed 509. No redemption data is captured for an advertisement 510.

With respect to the QR Offer Code 504, a redemption button is shown 511 with the offer and short description 512. If the offer is tapped via a touchscreen device or otherwise selected, the long description is then displayed 513. If the redemption button is selected 514, the system determines if the redemption limit has been reached 515 and if so, the system displays “Offer has already been redeemed the maximum amount of times”. If not, the display confirms the offer redemption 526 and, if confirmed, the QR code offer is displayed with a message to “Please show offer code to cashier before pressing the close button” 516. When the close button is selected, redemption data is captured and 1 is subtracted from the total redemption limit 517.

With respect to the UPC/PLU 505, a redemption button is shown 518 with the offer and short description 519. If the offer is tapped via a touchscreen device or otherwise selected, the long description is then displayed 520 If the redemption button is selected 521, the system determines if the redemption limit has been reached 522 and if so, the system displays “Offer has already been redeemed the maximum amount of times”. If not, the display confirms the offer redemption 523 and, if confirmed, a barcode image is displayed with a message to “Please ask cashier to scan barcode before pressing the close button” 5124 When the close button is selected, redemption data is captured and 1 is subtracted from the total redemption limit 525.

With respect to Continuity (Buy X Get Y Free) 506, element “A” 526 depicts the connection point between FIGS. 5a and 5b. Continuity (Buy X Get Y Free) 506 first requires that a purchase amount be met 527. If the purchase amount has been met, a redemption button is shown 536 with the redemption image 537. If the offer is tapped via a touchscreen device or otherwise selected, the long description is then displayed 538. If the redemption button is selected 539, the system determines if the customer has already redeemed the offer 540 and if so, the system displays “Thank you for using the offer. Enjoy your offer” 541 and when the close button is selected, redemption data is captured and the offer is removed from the device if the redemption limit has been met or if it has not been met, reset the purchased count to 0 542. If the customer has not redeemed the offer, the process returns to step 537 and displays the redemption image.

If the purchase amount has not been reached in step 527, a message is displayed that reads “You have purchased X out of Y items” 528 and then the offer image and short description is shown 529. If the offer is tapped via a touchscreen device or otherwise selected, the long description is then displayed 530. If the QR button is tapped 531, a scanner application is opened and reads “Please make your purchase and then scan the QR code on the sign” 532. If the QR code is not scanned or found invalid 533, the process returns to step 528. If the QR code is scanned and valid against the correct code on the phone 533 a beep or other notification sound is played and the scanner application is closed 534 and redemption data is captured and the amount of purchased items is incremented by one 535.

### EXAMPLES

The following exemplary offer structures illustrate certain embodiments of the methods and systems described herein and can be used independently or in combination.

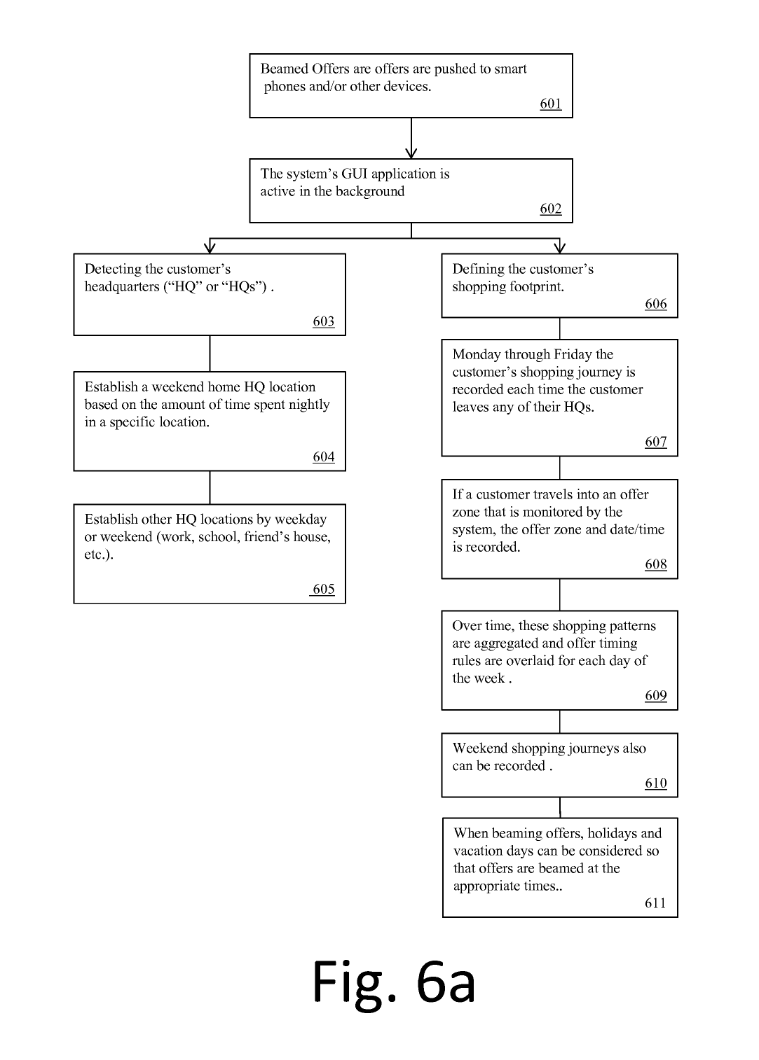

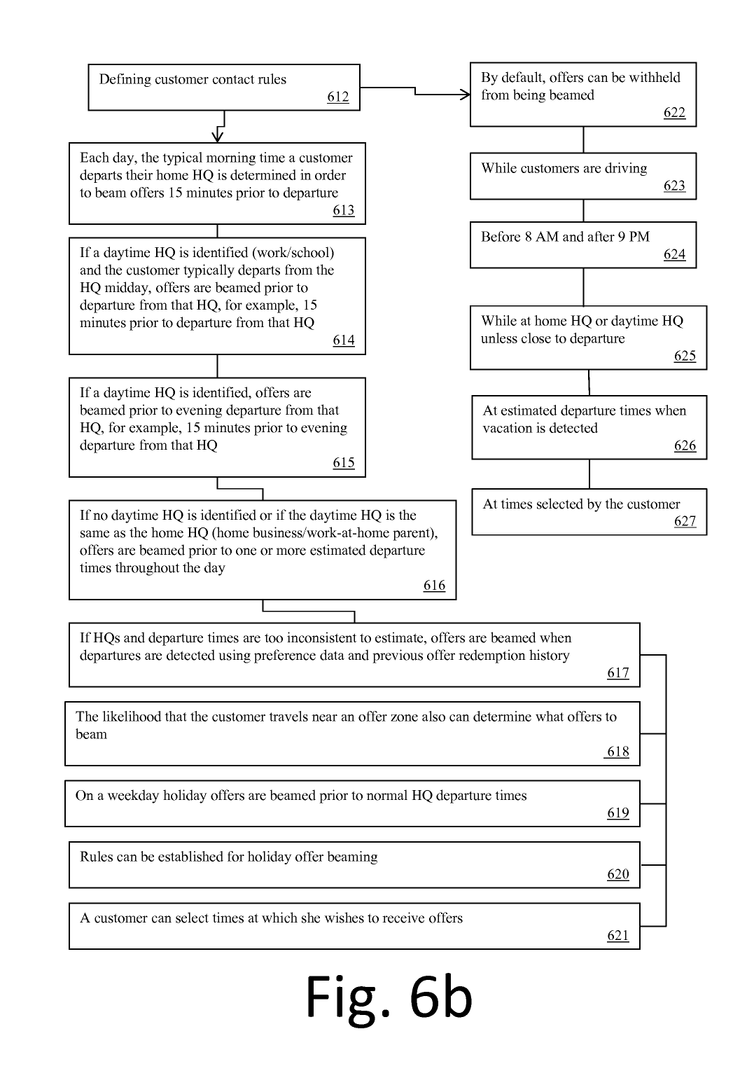

Now referring to FIG. 6a, Beamed Offers 600 are offers are pushed to smart phones and/or other devices 601 while the system's GUI application is active in the background 602. These are not necessarily offers in close proximity to a customer's current location. For example, the offers can be generated or selected based on one or more of the following steps: Detecting the customer's headquarters (“HQ” or “HQs”) 603. HQs are determine where customers may live, work, go to school or others based of behaviors determined by their latitude and longitude, cell tower radius. A customer's home HQ location can established based on the amount of time spent nightly in a specific location. This can be determined, for example, by GPS polling, including one or more of the following: Establish a weekend home HQ location based on the amount of time spent nightly in a specific location 604. Establish other HQ locations by weekday or weekend (work, school, friend's house, etc.) 605. In certain instances, determining the customer's HQ can be foundational in predicting what time a customer is likely to depart from an HQ and what offer zones the customer will likely traverse. The method of the present invention can use customers HQs as well as their previous customer journey patterns captured from their latitude and longitude, cell tower, or WiFi to determine the most relevant time to send offers/advertising/communication to customers to best influence their shopping journey.

Using GPS polling data can provide a customer's typical boundary limits traveled by the customer over a period of time 606, also referred to as defining the customer's shopping footprint. In certain instances, the customer's footprint is not merely the largest area traveled by the customer in a period of time, but can include the geographic area that comprises the number of offer zones in which the customer spends the majority of their time. For example, detecting the customer's shopping journey can include one or more of the following actions: Monday through Friday the customer's shopping journey is recorded each time the customer leaves any of their HQs 607. If a customer travels into an offer zone that is monitored by the system, the offer zone and date/time is recorded 608. Over time, these shopping patterns are aggregated and offer timing rules are overlaid for each day of the week 609. Weekend shopping journeys also can be recorded 610. When beaming offers, holidays and vacation days can be considered so that offers are beamed at the appropriate times 611.

Now referring to FIG. 6b, the method for defining customer contact rules 612 for the beamed offers is illustrated. Customer contact rules can include various rules, for example, one or more of the following: Each day, the typical morning time a customer departs their home HQ is determined in order to beam offers 15 minutes prior to departure 613. If a daytime HQ is identified (work/school) and the customer typically departs from the HQ midday, offers are beamed prior to departure from that HQ, for example, 15 minutes prior to departure from that HQ 614. If a daytime HQ is identified, offers are beamed prior to evening departure from that HQ, for example, 15 minutes prior to evening departure from that HQ 615. If no daytime HQ is identified or if the daytime HQ is the same as the home HQ (home business/work-at-home parent), offers are beamed prior to one or more estimated departure times throughout the day 616. If HQs and departure times are too inconsistent to estimate, offers are beamed when departures are detected using preference data and previous offer redemption history 617. The likelihood that the customer travels near an offer zone also can determine what offers to beam 618. On a weekday holiday (Memorial Day, Thanksgiving) offers are beamed prior to normal HQ departure times 619. Separate rules can be established for holiday offer beaming 620. A customer can select times at which she wishes to receive offers 621. By default, offers can be withheld from being beamed 622: While customers are driving 623; Before 8 AM and after 9 PM (unless actual departure times) 624; While at home HQ or daytime HQ unless close to departure 625; At estimated departure times when vacation is detected 626; and At times selected by the customer 627.

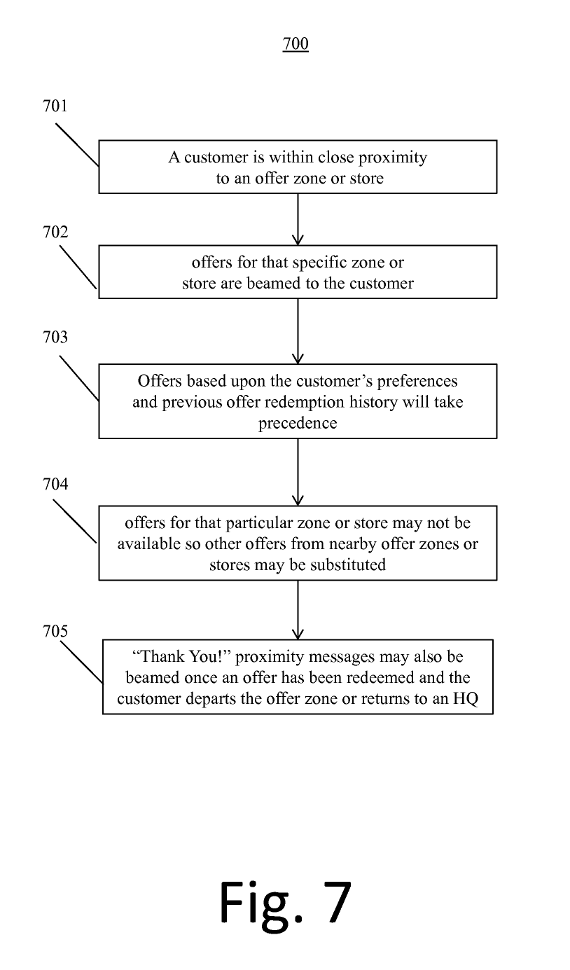

Now referring to FIG. 7, Proximity Offers are offers pushed to smart phones or other devices when a customer is within close proximity to an offer zone or specific retail location 700. When a customer is within close proximity to an offer zone or store 701, offers for that specific zone or store are beamed to the customer 702. Offers based upon the customer's preferences and previous offer redemption history will take precedence 703. In some instances, offers for that particular zone or store may not be available so other offers from nearby offer zones or stores may be substituted 704. “Thank You!” proximity messages may also be beamed once an offer has been redeemed and the customer departs the offer zone or returns to an HQ 705.

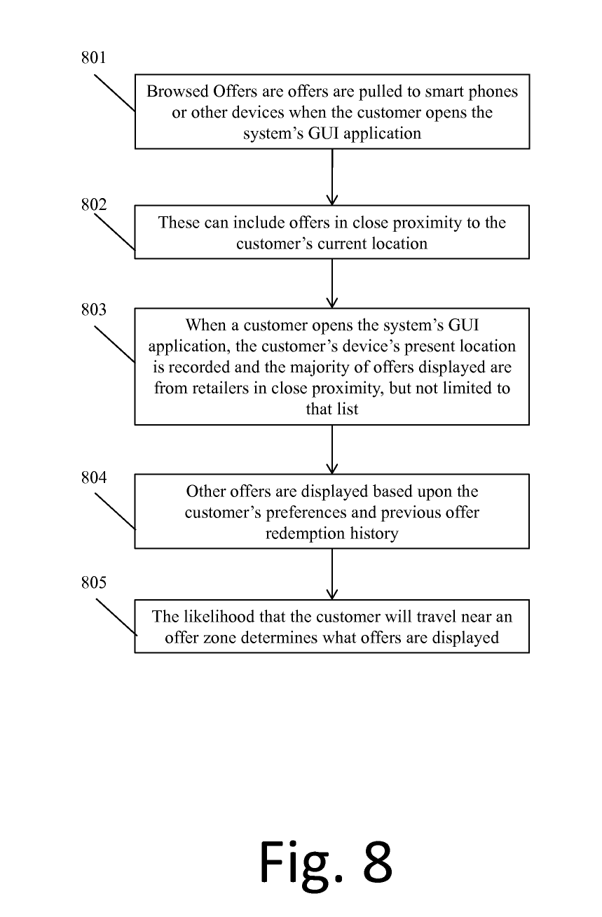

Now referring to FIG. 8, Browsed Offers are offers are pulled to smart phones or other devices when the customer opens the system's GUI (Graphical user Interface which is the display screen a customer views) application 801. These can include offers in close proximity to the customer's current location 802. When a customer opens the system's GUI application, the customer's device's present location is recorded and the majority of offers displayed are from retailers in close proximity, but not limited to that list 803. Other offers are displayed based upon the customer's preferences and previous offer redemption history 804. The likelihood that the customer will travel near an offer zone determines what offers are displayed 805. This method is used for the first time the system software is installed and activated.

In an alternative embodiment, the present invention may further include a campaign management system with a targeting engine to deliver the right offers to the right customers at the right time may be implemented.

A Real time web Campaign management system to allow retailers/manufactures/partners the ability to target customers instantly based of set of predefined, or custom targeting programs such as invite to automatically send offers to customers once they park or are within a radius of the retailer and have been in that radius for x amount of seconds. Other types of campaign such win or up-sell but not limited to will also send offers, advertising or communication to customers based of set of behaviors and customer journey. For example retailers can set campaigns to send offers to customers once the customers park or is within the retailers competitive establishment. these can be triggered to customers based on customer journey (latitude and longitude), redemption, interaction with the app or set of behaviors such as visiting other retailers or a multiple set of retailers and behaviors. A set of predefined real time reports allows these retailers to see their customers or potential customer movements, interaction with the app as well as prediction and behaviors, tallies, totals and counts.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for delivering content to or generating content within an individual's electronic device, comprising the steps of:
tracking more than one cycle of the individual's journey behavior by an electronic device;
comparing one or more tracked cycles;
identifying, from the comparison of the more than one tracked cycle, a pattern in the individual's journey behavior;
predicting the individual's future journey behavior;
determining one or more offers or messages to make to the individual based on the predicted future journey behavior for the individual; and
presenting one or more offers or messages to the individual through the electronic device.

2. The method of claim 1, further comprising the step of
determining the individual's location, route, timing, duration, or travel sequence as a component of the predicted individual future journey behavior.

3. The method of claim 1, wherein the more than one tracked cycle comprises a daily, day-to-day, weekly, monthly, or annual cycle.

4. The method of claim 1, wherein the delivery of one or more offers is by means of e-mail.

5. The method of claim 1, wherein the delivery of one or more offers is by means of text messaging.

6. The method of claim 1, wherein the delivery of one or more offers is by means of a phone call.

7. The method of claim 1, wherein the delivery of one or more offers is by means of any notification method including push notification and or internal device alerts to the phone, handheld, or mobile device.

8. A method for identifying when to deliver or generate offer beams, push notifications, internal device prompts, or other message alerts or content to an electronic devices, comprising the steps of:
capturing the electronic devices' GPS locations, core locations, cell tower triangulated locations, WiFi, GPS, or geo-fencing locations;
capturing and determining the possible locations where the delivery or generation of the offer beams or other content could occur, based on predefined locations or derived locations;
comparing one or more of the captured devices' locations to one or more of the possible delivery locations;
identifying, from the comparison of the captured devices' locations and possible delivery locations, whether the devices are within certain proximity to one or more of the possible delivery locations;
identifying, from durations of time the devices have spent within certain proximity to the possible delivery locations, whether the devices continue to remain within certain proximity to the delivery locations or have departed from a certain proximity to the delivery locations;
determining, from all the possible delivery locations, the identification of whether the devices continue to remain within or have departed from a certain proximity to the possible delivery locations;
determining which finale delivery location or locations will be where the delivery or generation of the offer beams or other content will occur;
determining the durations of time that should elapse between identifying the finale delivery locations and delivering or generating the offer beams or other content to the devices; and
delivering or generating one or more types or categories of offer beams or other content to the individuals' devices.

9. The method of claim 8, wherein, the identification of whether the devices continue to remain within or have departed from a certain proximity to the possible delivery locations depends on the delivery locations sizes, types or categories, proximity to one another, and distances from the devices.

10. The method of claim 8, wherein, the determination of the durations of time that should elapse between identifying the finale delivery locations and delivering or generating the offer beams or other content to the devices is based on the finale delivery locations' sizes, types or categories, distances from the devices and the travel directions of the devices, types or categories of offer beams or content, or other information associated with the finale delivery locations and devices.

11. The method of claim 8, further comprising the steps of:
pulling data from one or more of an individual's mobile devices, the data comprising data selected from a group consisting of location, route, timing, duration, or travel sequence data;
storing the data into a database;
building, from the database, one or more historical journey patterns for the individual;
forecasting a trend from the one or more historical journey patterns; and
using the forecasted to deliver an offer or message to the individual prior to the individual arriving at a predetermined location or upon the individual's arrival at a predetermined location or upon the individual's departure from a predetermined location once the individual is within a detectable proximity to a predetermined location.

12. The method of claim 11, wherein the data includes data regarding retailers and zones traveled and visited by the individual.

13. The method of claim 11, wherein the data comprises day and time of day data and uses latitude and longitude location data from the mobile device, personal computers, or any smart or handheld devices.

14. The method of claim 13, wherein the data is derived from one or more of devices' core locations, cell tower triangulated location, WiFi, GPS, geo-fencing location, route-, timing-, duration-, and/or sequence-based information.

15. A system for delivering one or more offers or messages to an individual, the system comprising:
a database of historical journey pattern information about an individual's recurring travel or shopping habits;
one or more rules for (i) predicting within, desired confidence levels, the individual's journey and time of that journey, and (ii) selecting one or more offers for the individual; and
a signal transmitted to one of more of the individual's devices that provides the one or more offers prior, during, or after the individual's journey as an incentive for the individual to modify his or her journey or future journeys.

16. The system of claim 15, wherein the database includes historical latitude and longitude information about the individual's journey.

17. The system of claim 15, wherein the rules comprise one or more rules selected from the group consisting of:
rules to qualify offers;
rules to rate or rank offers;
rules to sequence offers;
rules inputted by retailers;
rules inputted by individuals;
rules to generate trend data about an individual's journeys;
rules to identify an individual's daily, day-to-day, weekly, monthly or annual behavior; and
rules to predict optimum delivery, time, frequency, or location for presenting the offer or message to the individual; and rules for forming a retailer's campaign interests.

18. The system of claim 15, further comprising the steps of
analyzing an individual's location data; and
determining one or more individual headquarters based on duration and frequency of location data for one or more locations.

19. The system of claim 18, further comprising the steps for determining one or more individual headquarters:
determining the amount of time spent in a specific location by frequently capturing the electronic device's core location, cell tower triangulated location, WiFi, GPS, or geo-fencing information;
establishing a primary weekday and a weekend HQ locations based on the amount of time spent in a specific location; and
establishing one or more alternative HQ locations by weekday or weekend.

20. The system of claim 15, wherein the pulled data frequency is adjusted based on the device's battery life.
